(19) United States
(12) Patent Application Publication
(10) Pub. No.: US 2021/0337061 A1
(43) Pub. Date: Oct. 28, 2021

(54) METHOD, DEVICE FOR PROCESSING MESSAGE IN SCREEN LOCKED INTERFACE AND ELECTRONIC DEVICE

(71) Applicant: BEIJING KINGSOFT INTERNET SECURITY SOFTWARE CO., LTD., Beijing (CN)

(72) Inventor: JIE FANG, Beijing (CN)

(21) Appl. No.: 16/476,400

(22) PCT Filed: Nov. 23, 2017
(86) PCT No.: PCT/CN2017/112694

§ 371 Date: Jul. 8, 2019

(30) Foreign Application Priority Data
Jun. 28, 2017 (CN) 201710510251.8

(51) Int. Cl. H04M 1/72436; H04L 12/58; H04W 8/22; H04W 4/12; H04M 1/72463

(52) U.S. Cl. CPC H04M 1/72436; H04L 51/046; H04M 1/72463; H04W 4/12; H04W 8/22

(57) ABSTRACT

The present disclosure provides a method and a device for processing a message on a screen locked interface, and an electronic device. The method includes: obtaining a message of an application notification bar in response to that the application notification bar is triggered by an operating system of an electronic device; updating a message list based on the message; detecting a current state of the electronic device; and forbidding displaying the message list on a main interface of the electronic device in response to that the current state is a screen unlocked state, the message list being configured to be displayed in response to that the electronic device is in a screen locked state.

### CROSS-REFERENCE TO RELATED APPLICATIONS

This application claims priority to and benefits of Chinese Patent Application Serial No. 201710510251.8, filed with the National Intellectual Property Administration of P. R. China on Jun. 28, 2017 by BEIJING KINGSOFT INTERNET SECURITY SOFTWARE CO., LTD, and titled with “METHOD AND DEVICE FOR PROCESSING MESSAGE IN SCREEN LOCKED INTERFACE, AND ELECTRONIC DEVICE”, the entire content of which is incorporated herein by reference.

### TECHNICAL FIELD

The present disclosure relates to the field of electronic device technologies, and more particularly, to a method and a device for processing a message on a screen locked interface, and an electronic device.

### BACKGROUND

In the related art, when the electronic device receives the message in the screen locked state, a message list will be displayed, i.e., a message list is displayed on the screen locked interface of the electronic device using screen lock message technology. The message list is bound to the screen locked interface, that is, when the electronic device is in the screen locked state, the message list will be created or updated, and displayed on the screen locked interface, and the lifecycle of the message list is bound to the screen locked interface. When the interface is unlocked, the message list will be deleted accordingly.

In this way, the message received when the electronic device is in the screen unlocked state will not be parsed in the message list, and the integrity of the message is not good.

### SUMMARY

The present disclosure aims to solve at least one of the technical problems in the related art to at least some extent.

Accordingly, an objective of the present disclosure is to provide a method for processing a message on a screen locked interface, which can unbind the message list and the screen locked interface, guarantee the maintenance independence of the lifecycle of the message list, and improve the integrity and instantaneity of the message display.

Another objective of the present disclosure is to provide a device for processing a message on a screen locked interface.

Another objective of the present disclosure is to provide an electronic device.

Another objective of the present disclosure is to provide a non-transitory computer readable storage medium.

Another objective of the present disclosure is to provide a computer program product.

In order to achieve the above objectives, embodiments of a first aspect of the present disclosure provide a method for processing a message on a screen locked interface. The method includes: obtaining a message of an application notification bar in response to that the application notification bar is triggered by an operating system of an electronic device; updating a message list based on the message; detecting a current state of the electronic device; and forbidding displaying the message list on a main interface of the electronic device in response to that the current state is a screen unlocked state, the message list being configured to be displayed in response to that the electronic device is in a screen locked state.

In an embodiment of the present disclosure, after detecting the current state of the electronic device, the method further includes: displaying the message list on the screen locked interface of the electronic device in response to that the current state is the screen locked state.

In an embodiment of the present disclosure, after forbidding displaying the message list on the main interface of the electronic device, the method further includes: storing the message list into a local cache.

In an embodiment of the present disclosure, after forbidding displaying the message list on the main interface of the electronic device, the method further includes: detecting whether the electronic device re-enters into the screen locked state; and redisplaying the message list on the screen locked interface of the electronic device in response to that the electronic device re-enters into the screen locked state.

In an embodiment of the present disclosure, updating the message list based on the message includes: querying whether the message list is stored in the local cache; updating the message list directly based on the message in response to that there is the message list stored in the local cache; and establishing a message list, and taking the established message list as the message list in response to that there is no message list stored in the local cache.

In an embodiment of the present disclosure, before obtaining the message of the application notification bar, the method further includes: obtaining an access authority to the application notification bar.

In an embodiment of the present disclosure, the message is generated by an instant messaging application.

In an embodiment of the present disclosure, the message includes an icon of an application from which the message comes, the number of messages in a notification bar, a prompt mode of a notification bar, and a behavior mode after clicking a notification bar.

With the method for processing a message on a screen locked interface according to embodiments of the first aspect of the present disclosure, the message of the application notification bar is obtained in response to that the application notification bar is triggered by the operating system of the electronic device, the message list is updated based on the message, in response to that the electronic device is in the unlocked state, it is forbidden to display the message list on the main interface of the electronic device, the message list is configured to be displayed in response to that the electronic device is in the screen locked state, such that the message list and the screen locked interface can be unbound, the maintenance independence of the lifecycle of the message list can be guaranteed, and the integrity and instantaneity of the message display can be improved.

In order to achieve the above objectives, embodiments of a second aspect of the present disclosure provide a device for processing a message on a screen locked interface. The device includes a first obtaining module, an updating module, a detecting module, and a processing module. The first obtaining module is configured to obtain a message of an application notification bar in response to that the application notification bar is triggered by an operating system of an electronic device. The updating module is configured to update a message list based on the message. The detecting module is configured to detect a current state of the electronic device. The processing module is configured to forbid displaying the message list on a main interface of the electronic device in response to that the current state is a screen unlocked state. The message list is configured to be displayed in response to that the electronic device is in a screen locked state.

In an embodiment of the present disclosure, the processing module is further configured to display the message list on the screen locked interface of the electronic device in response to that the current state is the screen locked state.

In an embodiment of the present disclosure, the device further includes a storing module. The storing module is configured to store the message list into a local cache.

In an embodiment of the present disclosure, the detecting module is configured to detect whether the electronic device re-enters into the screen locked state; and redisplay the message list on the screen locked interface of the electronic device in response to that the electronic device re-enters into the screen locked state.

In an embodiment of the present disclosure, the updating module includes a querying sub module, and an updating sub module. The querying sub module is configured to query whether the message list is stored in the local cache. The updating sub module is configured to update the message list directly based on the message in response to that there is the message list stored in the local cache; and establish a message list, and take the established message list as the message list in response to that there is no message list stored in the local cache.

In an embodiment of the present disclosure, the device further includes a second obtaining module. The second obtaining is configured to obtain an access authority to the application notification bar.

In an embodiment of the present disclosure, the message is generated by an instant messaging application.

In an embodiment of the present disclosure, the message includes an icon of an application from which the message comes, the number of messages in a notification bar, a prompt mode of a notification bar, and a behavior mode after clicking a notification bar.

With the device for processing a message on a screen locked interface according to embodiments of the second aspect of the present disclosure, the message of the application notification bar is obtained in response to that the application notification bar is triggered by the operating system of the electronic device, the message list is updated based on the message, in response to that the electronic device is in the screen unlocked state, it is forbidden to display the message list on the main interface of the electronic device, the message list is configured to be displayed in response to that the electronic device is in the screen locked state, such that the message list and the screen locked interface can be unbound, the maintenance independence of the lifecycle of the message list can be guaranteed, and the integrity and instantaneity of the message display can be improved.

In order to achieve the above objectives, embodiments of a third aspect of the present disclosure provide an electronic device. The electronic device includes a processor, a memory, a power supply circuit, a multimedia component, an audio component, an input/output (I/O) interface, a sensor component, and a communication component. The circuit board is arranged in a space enclosed by a housing, and the processor and the memory are positioned on the circuit board. The power supply circuit is configured to provide power for respective circuits or components of the electronic device. The memory is configured to store executable program codes. The processor is configured to run a program corresponding to the executable program codes by reading the executable program codes stored in the memory, to: obtain a message of an application notification bar in response to that the application notification bar is triggered by an operating system of an electronic device; update a message list based on the message; detect a current state of the electronic device; and forbid displaying the message list on a main interface of the electronic device in response to that the current state is a screen unlocked state, the message list is configured to be displayed in response to that the electronic device is in a screen locked state.

In an embodiment of the present disclosure, the processor is further configured to display the message list on the screen locked interface of the electronic device in response to that the current state is the screen locked state.

In an embodiment of the present disclosure, the processor is further configured to store the message list into a local cache.

In an embodiment of the present disclosure, the processor is further configured to: detect whether the electronic device re-enters into the screen locked state; and redisplay the message list on the screen locked interface of the electronic device in response to that the electronic device re-enters into the screen locked state.

In an embodiment of the present disclosure, the processor is further configured to: query whether the message list is stored in the local cache; update the message list directly based on the message in response to that there is the message list stored in the local cache; and establish a message list, and take the established message list as the message list in response to that there is no message list stored in the local cache.

In an embodiment of the present disclosure, the processor is further configured to obtain an access authority to the application notification bar.

In an embodiment of the present disclosure, the message is generated by an instant messaging application.

In an embodiment of the present disclosure, the message includes an icon of an application from which the message comes, the number of messages in a notification bar, a prompt mode of a notification bar, and a behavior mode after clicking a notification bar.

With the electronic device according to embodiments of the third aspect of the present disclosure, the message of the application notification bar is obtained in response to that the application notification bar is triggered by the operating system of the electronic device, the message list is updated based on the message, in response to that the electronic device is in the screen unlocked state, it is forbidden to display the message list on the main interface of the electronic device, the message list is configured to be displayed in response to that the electronic device is in the screen locked state, such that the message list and the screen locked interface can be unbound, the maintenance independence of the lifecycle of the message list can be guaranteed, and the integrity and instantaneity of the message display can be improved.

In order to achieve the above objectives, embodiments of a fourth aspect of the present disclosure provide a non-transitory computer readable storage medium. When the instructions in the storage medium are executed by a processor of a mobile terminal, causes the mobile terminal to perform method for processing a message on a screen locked interface. The method includes: obtaining a message of an application notification bar in response to that the application notification bar is triggered by an operating system of an electronic device; updating a message list based on the message; detecting a current state of the electronic device; and forbidding displaying the message list on a main interface of the electronic device in response to that the current state is a screen unlocked state, the message list being configured to be displayed in response to that the electronic device is in a screen locked state.

With the non-transitory computer readable storage medium according to embodiments of the fourth aspect of the present disclosure, the message of the application notification bar is obtained in response to that the application notification bar is triggered by the operating system of the electronic device, the message list is updated based on the message, in response to that the electronic device is in the screen unlocked state, it is forbidden to display the message list on the main interface of the electronic device, the message list is configured to be displayed in response to that the electronic device is in the screen locked state, such that the message list and the screen locked interface can be unbound, the maintenance independence of the lifecycle of the message list can be guaranteed, and the integrity and instantaneity of the message display can be improved.

In order to achieve the above objectives, embodiments of a fifth aspect of the present disclosure provide a computer program product. When the instructions in the storage medium are executed by a processor, causes the method for processing a message on a screen locked interface to be performed. The method includes: obtaining a message of an application notification bar in response to that the application notification bar is triggered by an operating system of an electronic device; updating a message list based on the message; detecting a current state of the electronic device; and forbidding displaying the message list on a main interface of the electronic device in response to that the current state is a screen unlocked state, the message list being configured to be displayed in response to that the electronic device is in a screen locked state.

With the computer program product according to embodiments of the fifth aspect of the present disclosure, the message of the application notification bar is obtained in response to that the application notification bar is triggered by the operating system of the electronic device, the message list is updated based on the message, in response to that the electronic device is in the screen unlocked state, it is forbidden to display the message list on the main interface of the electronic device, the message list is configured to be displayed in response to that the electronic device is in the screen locked state, such that the message list and the screen locked interface can be unbound, the maintenance independence of the lifecycle of the message list can be guaranteed, and the integrity and instantaneity of the message display can be improved.

Additional aspects and advantages of embodiments of present disclosure will be given in part in the following descriptions, become apparent in part from the following descriptions, or be learned from the practice of the embodiments of the present disclosure.

### BRIEF DESCRIPTION OF THE DRAWINGS

These and other aspects and advantages of embodiments of the present disclosure will become apparent and more readily appreciated from the following descriptions made with reference to the accompanying drawings, in which:

FIG. 1 is a flow chart of a method for processing a message on a screen locked interface according to an embodiment of the present disclosure;

FIG. 2 is a flow chart of a method for processing a message on a screen locked interface according to another embodiment of the present disclosure;

FIG. 3 is a schematic diagram of a message list according to an embodiment of the present disclosure;

FIG. 4 is a flow chart of a method for processing a message on a screen locked interface according to another embodiment of the present disclosure;

FIG. 5 is a block diagram a device for processing a message on a screen locked interface according to an embodiment of the present disclosure;

FIG. 6 is a block diagram a device for processing a message on a screen locked interface according to another embodiment of the present disclosure;

FIG. 7 is a schematic diagram of an electronic device according to an embodiment of the present disclosure.

### DETAILED DESCRIPTION

Reference will be made in detail to embodiments of the present disclosure. Embodiments of the present disclosure will be shown in drawings, in which the same or similar elements and the elements having same or similar functions are denoted by like reference numerals throughout the descriptions. The embodiments described herein according to drawings are explanatory, intended to explain the present disclosure, and not construed to limit the present disclosure. Instead, the embodiments of the present disclosure include all the variants, modifications and their equivalents within the spirit and scope of the present disclosure as defined by the claims.

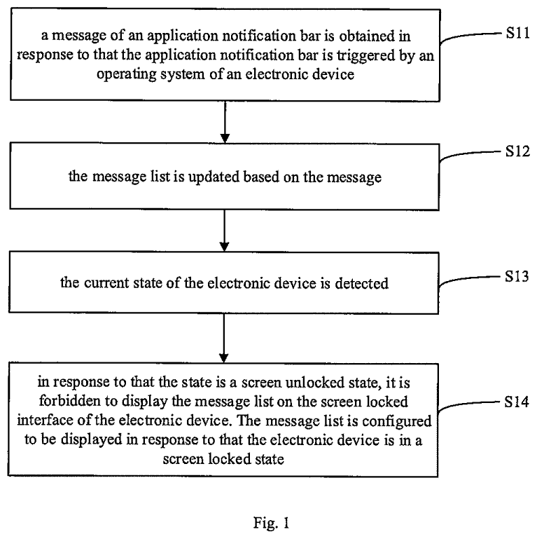

FIG. 1 is a flow chart of a method for processing a message on a screen locked interface according to an embodiment of the present disclosure.

It should be noted that, the execution subject of embodiments of the present disclosure may be, in hardware, for example, a central processing unit (CPU) of the terminal, and may be, in software, for example, the related service of a control type application for the message on the screen locked interface in the terminal.

Referring to FIG. 1, the method may include the followings.

At block S11, a message of an application notification bar is obtained in response to that the application notification bar is triggered by an operating system of an electronic device.

The application may refer to the software program running on the electronic device. The electronic device may be, for example, a personal computer (PC), a cloud device or a mobile device. The mobile device may be, for example, a smart phone, or a tablet, etc.

The operating system (OS) is the computer program that manages and controls hardware and software resources of the computer. The operating system is the most basic system software running directly on the “bare machine”, and any other software should be supported by the operating system to run.

The application notification bar refers to the interface area for displaying incoming call information, application information, or other information in an electronic device.

Alternatively, the message is generated by an instant messaging application.

Alternatively, the message includes an icon of an application from which the message comes, the number of messages in a notification bar, a prompt mode of a notification bar, and a behavior mode after clicking a notification bar.

The icon of the application from which the message comes may be, for example, a penguin icon of the communication tool QQ of Tencent.

The number of messages in the notification bar may be the number of messages received by the application corresponding to the application notification bar in the time period from the moment when the operating system last intercepted the application notification bar to the current time of the system. The number of messages in the notification bar may be, for example, three.

The prompt mode of the notification bar may be, for example, the opening of the light of the mobile phone, or the vibration of the mobile phone, or the flashing of the icon, when the mobile phone receives the new message.

The behavior mode after the notification bar is clicked may be, for example, inputting of the password to unlock the mobile phone.

For example, when the application of the mobile terminal monitors that the mobile phone receives the new QQ message, the icon of the QQ application, the number of the QQ messages, the prompt mode of the notification bar, and the behavior mode after the notification bar is clicked can be intercepted and obtained.

In an embodiment of the present disclosure, the operation of the operating system of the electronic device may be monitored first, and it is determined whether the operating system triggers the application notification bar, and then block S11 is triggered or not triggered according to the determination result.

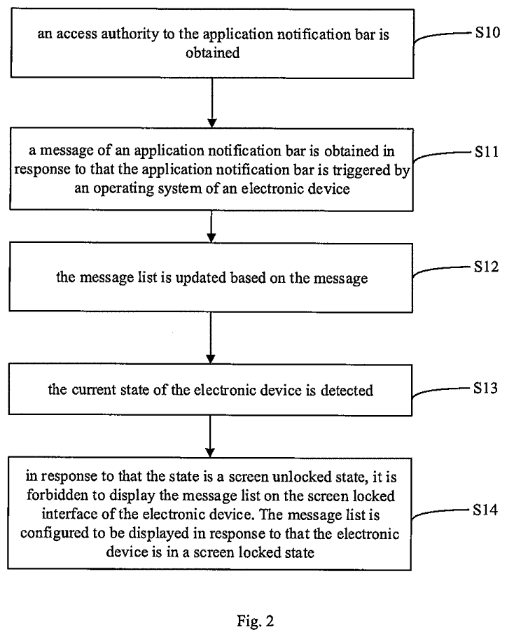

Furthermore, before the message of the application notification bar is obtained, referring to FIG. 2, the method further includes the followings.

At block S10, an access authority to the application notification bar is obtained.

The access authority may be preset by the user in the operating system.

At block S12, the message list is updated based on the message.

In an embodiment of the present disclosure, the message list may be configured to be displayed in response to that the electronic device is in the screen locked state, and the message list may be, for example, a display notification bar.

Specifically, the message list may be updated according to the icon of the application from which the message comes, the number of messages in the notification bar, the prompt mode of the notification bar, and the behavior mode after the notification bar is clicked.

The message list may refer to the interface area in the electronic device for displaying incoming call information, application information, or other information. Unlike the application notification bar, the message list does not display the user's private information, the security of user's private data can be effectively improved.

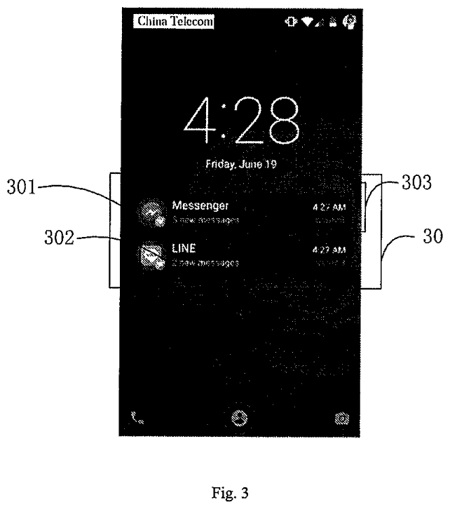

For example, referring to FIG. 3, FIG. 3 is a schematic diagram of a message list according to an embodiment of the present disclosure. The message list 30 includes the icon 301 of the application from which the message comes, the number of messages 302 in the notification bar, and the current system time 303.

In the embodiment of the present disclosure, by updating the message list according to the message of the application notification bar, the message list and the message content of the application notification bar can be synchronized. When the message of the application notification bar changes, the corresponding update operation on the message list can be triggered. On the other hand, when the message list is operated by the user, the application notification bar may also be synchronously updated, such that the consistency of the message in the message list and the message of the application notification bar can be ensured efficiently.

At block S13, the current state of the electronic device is detected.

The state may be the screen locked state or the screen unlocked state.

In an embodiment of the present disclosure, the current state of the electronic device can be detected by the operating system interface.

In the related art, at block S12, the message list is configured to be displayed in response to that the electronic device is in the screen locked state, i.e., the message list is displayed on the screen locked interface of the electronic device using screen lock message technology. The message list is bound to the screen locked interface, that is, in response to that the electronic device is in the screen locked state, the message list will be created or updated, and displayed on the screen locked interface, and the lifecycle of the message list is bound to the screen locked interface.

In the embodiment of the present disclosure, after the operating system of the electronic device triggers the application notification bar, the display of the message list may be controlled according to the current state of the electronic device, the message list and the screen locked interface can be unbound, the maintenance independence of the lifecycle of the message list can be guaranteed, such that the message list displayed on the lock screen interface can be updated in real time only in response to that the electronic device is in the screen unlocked state, and the integrity and instantaneity of the message display can be improved.

At block S14, in response to that the state is a screen unlocked state, it is forbidden to display the message list on the screen locked interface of the electronic device. The message list is configured to be displayed in response to that the electronic device is in a screen locked state.

In the embodiment of the present disclosure, the display attribute of the message list can be set by the operating system interface, and can be set to be invisible, to make the message list in the invisible state on the main interface of the electronic device. Moreover, the message list may still be updated in real time, thereby unbinding the message list and the screen locked interface, and ensuring the maintenance independence of the lifecycle of the message list.

In the embodiment, the message of the application notification bar is obtained in response to that the application notification bar is triggered by the operating system of the electronic device, the message list is updated based on the message, in response to that the electronic device is in the screen unlocked state, it is forbidden to display the message list on the main interface of the electronic device, the message list is configured to be displayed in response to that the electronic device is in the screen locked state, such that the message list and the screen locked interface can be unbound, the maintenance independence of the lifecycle of the message list can be guaranteed, and the integrity and instantaneity of the message display can be improved.

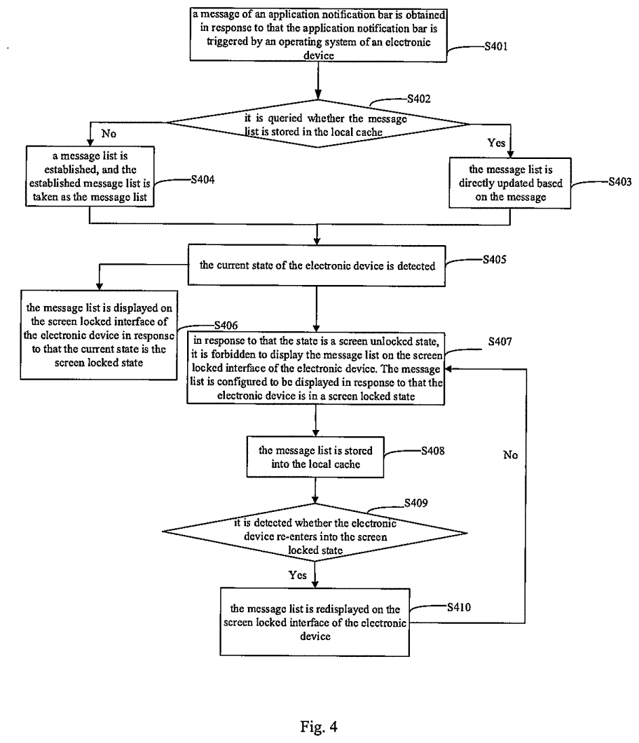

FIG. 4 is a schematic diagram of a message list according to an embodiment of the present disclosure.

Referring to FIG. 4, the method may include the followings.

At block S401, a message of an application notification bar is obtained in response to that the application notification bar is triggered by an operating system of an electronic device.

The execution process of this block may be referred to the above embodiments, and will not be repeated here.

At block S402, it is queried whether the message list is stored in the local cache, if yes, block S403 is performed, and otherwise, block S404 is performed.

In the embodiment of the present disclosure, each time the message list is updated, it may be stored in the local cache of the electronic device, to ensure the integrity of the message.

At block S403, the message list is directly updated based on the message.

At block S404, a message list is established, and the established message list is taken as the message list.

Therefore, in the embodiment of the present disclosure, when it is queried that there is message list stored in the local cache, it can be updated directly, and in response to that there is no message list stored in the local cache, a message list can be established. For example, the message list may be established by customizing a messenger widget, and maintaining a dynamic list view inherited from recycler view in the widget.

By updating or establishing the message list when the operating system of the electronic device triggers the application notification bar, the consistency of the message in the message list and the message of the application notification bar can further be efficiently ensured.

At block S405, the current state of the electronic device is detected.

At block S406, the message list is displayed on the screen locked interface of the electronic device in response to that the current state is the screen locked state.

In the embodiment of the present disclosure, when the state is the screen locked state, the message list can be displayed on the screen locked interface of the electronic device. The display attribute of the message list can be set by the operating system interface, in response to that the electronic device is in the screen locked state, it may be set to be visible, such that the message list may be visible on the screen locked interface of the electronic device, ensuring that the message list will not be destroyed with the disappearance of the screen locked interface, ensuring that the message list can be updated and maintained dynamically and in real time, and effectively avoiding the omission of the message caused by unlocking of the electronic device due to the user's misoperation.

At block S407, in response to that the state is a screen unlocked state, it is forbidden to display the message list on the screen locked interface of the electronic device. The message list is configured to be displayed in response to that the electronic device is in a screen locked state.

At block S408, the message list is stored into the local cache.

In an embodiment of the present disclosure, each time the message list is updated, it may be stored in the local cache of the electronic device, to ensure the integrity of the message.

At block S409, it is detected whether the electronic device re-enters into the screen locked state, if yes, block S410 is performed, and otherwise, block S407 is repeated.

At block S410, the message list is redisplayed on the screen locked interface of the electronic device.

In the embodiment of the present disclosure, when the electronic device reenters the screen locked state, the message list can be redisplayed on the screen locked interface of the electronic device. Since the message list is stored in the local cache of the electronic device when the electronic device is unlocked, compared to the related art, the establishment of the message list can be omitted when the electronic device is locked, and the message list can be displayed faster in response to that the electronic device is locked, the display efficiency of the message list can be improved.

Furthermore, in the embodiment of the present disclosure, the message list may be deleted based on the user operation, rather than destroying it each time the electronic device is unlocked, the operation efficiency of the electronic device can be effectively improved.

In the embodiment, the message of the application notification bar is obtained in response to that the application notification bar is triggered by the operating system of the electronic device, the message list is updated based on the message, in response to that the electronic device is in the screen unlocked state, it is forbidden to display the message list on the main interface of the electronic device, the message list is configured to be displayed in response to that the electronic device is in the screen locked state, such that the message list and the screen locked interface can be unbound, the maintenance independence of the lifecycle of the message list can be guaranteed, and the integrity and instantaneity of the message display can be improved. By updating or establishing the message list when the operating system of the electronic device triggers the application notification bar, the consistency of the message in the message list and the message of the application notification bar can further be efficiently ensured. Each time the message list is updated, it can be stored in the local cache of the electronic device, to ensure the integrity of the message. When the electronic device reenters the screen locked state, the message list can be redisplayed on the screen locked interface of the electronic device, since the message list is stored in the local cache of the electronic device when the electronic device is unlocked, compared to the related art, the establishment of the message list can be omitted when the electronic device is locked, and the message list can be displayed faster when the electronic device is locked, the display efficiency of the message list can be improved.

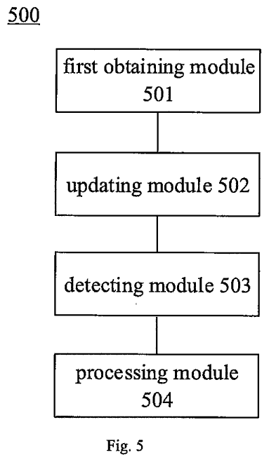

FIG. 5 is a block diagram a device for processing a message on a screen locked interface according to an embodiment of the present disclosure.

Referring to FIG. 5, the device 500 may include a first obtaining module 501, an updating module 502, a detecting module 503, and a processing module 504. The first obtaining module 501 is configured to obtain a message of an application notification bar in response to that the application notification bar is triggered by an operating system of an electronic device. The updating module 502 is configured to update a message list based on the message. The detecting module 503 is configured to detect a current state of the electronic device. The processing module 504 is configured to forbid displaying the message list on a main interface of the electronic device in response to that the current state is a screen unlocked state. The message list is configured to be displayed in response to that the electronic device is in a screen locked state.

Alternatively, in an embodiment, the processing module 504 is further configured to display the message list on the screen locked interface of the electronic device in response to that the current state is the screen locked state.

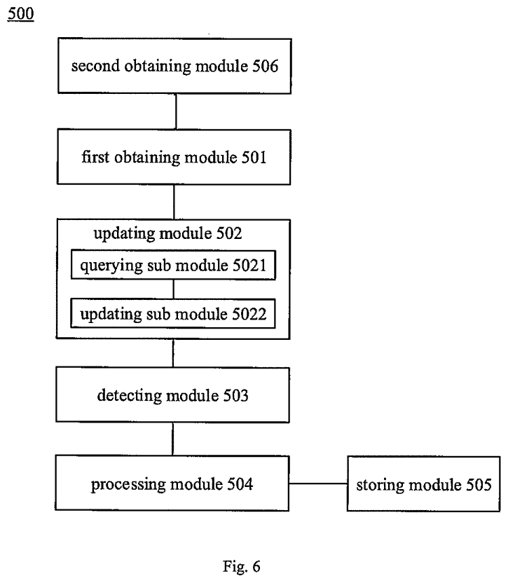

Alternatively, in an embodiment, referring to FIG. 6, the device 500 further includes a storing module 505 and a second obtaining module 506. The storing module 505 is configured to store the message list into a local cache. The second obtaining 506 is configured to obtain an access authority to the application notification bar.

Alternatively, in an embodiment, the detecting module 503 is configured to detect whether the electronic device re-enters into the screen locked state, and trigger the processing module 504 to redisplay the message list on the screen locked interface of the electronic device in response to that the electronic device re-enters into the screen locked state.

Alternatively, in an embodiment, referring to FIG. 6, the updating module 502 includes a querying sub module 5021, and an updating sub module 5022. The querying sub module 5021 is configured to query whether the message list is stored in the local cache. The updating sub module 5022 is configured to update the message list directly based on the message in response to that there is the message list stored in the local cache; and establish a message list, and take the established message list as the message list in response to that there is no message list stored in the local cache.

Alternatively, the message is generated by an instant messaging application.

Alternatively, the message includes an icon of an application from which the message comes, the number of messages in a notification bar, a prompt mode of a notification bar, and a behavior mode after clicking a notification bar.

It should be noted that, the explanation of embodiments of the method for processing a message on a screen locked interface in the foregoing embodiments of FIG. 1 to FIG. 4 may also be applicable to the device 500 for processing a message on a screen locked interface in the embodiment, the implementation principle is similar, and details are not described herein again.

In the embodiment, the message of the application notification bar is obtained in response to that the application notification bar is triggered by the operating system of the electronic device, the message list is updated based on the message, in response to that the electronic device is in the screen unlocked state, it is forbidden to display the message list on the main interface of the electronic device, the message list is configured to be displayed in response to that the electronic device is in the screen locked state, such that the message list and the screen locked interface can be unbound, the maintenance independence of the lifecycle of the message list can be guaranteed, and the integrity and instantaneity of the message display can be improved.

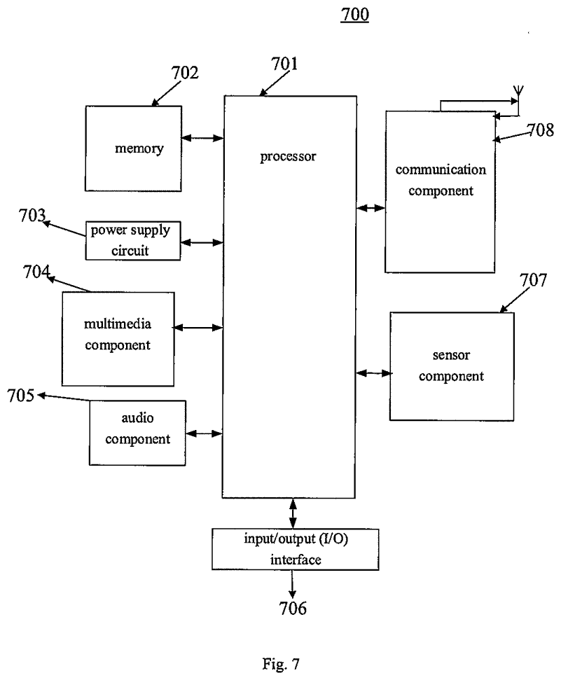

Embodiments of the present disclosure further provide an electronic device. Referring to FIG. 7, the electronic device 700 includes one or more components of a processor 701, a memory 702, a power supply circuit 703, a multimedia component 704, an audio component 705, an input/output (I/O) interface 706, a sensor component 707, and a communication component 708.

The power supply circuit 703 is configured to provide power for respective circuits or components of the electronic device. The memory 702 is configured to store executable program codes. The processor 701 is configured to run a program corresponding to the executable program codes by reading the executable program codes stored in the memory, to: obtain a message of an application notification bar in response to that the application notification bar is triggered by an operating system of an electronic device; update a message list based on the message; detect a current state of the electronic device; and forbid displaying the message list on a main interface of the electronic device in response to that the current state is a screen unlocked state, the message list is configured to be displayed in response to that the electronic device is in a screen locked state.

It should be noted that, the explanation of embodiments of the method for processing a message on a screen locked interface in the foregoing embodiments of FIG. 1 to FIG. 4 may also be applicable to the electronic device 700 in the embodiment, the implementation principle is similar, and details are not described herein again.

In the embodiment, the message of the application notification bar is obtained in response to that the application notification bar is triggered by the operating system of the electronic device, the message list is updated based on the message, in response to that the electronic device is in the screen unlocked state, it is forbidden to display the message list on the main interface of the electronic device, the message list is configured to be displayed in response to that the electronic device is in the screen locked state, such that the message list and the screen locked interface can be unbound, the maintenance independence of the lifecycle of the message list can be guaranteed, and the integrity and instantaneity of the message display can be improved.

In order to achieve the above embodiments, the present disclosure further provides a non-transitory computer readable storage medium. When the instructions in the storage medium are executed by a processor of a terminal, causes the terminal to perform method for processing a message on a screen locked interface. The method includes: obtaining a message of an application notification bar in response to that the application notification bar is triggered by an operating system of an electronic device; updating a message list based on the message; detecting a current state of the electronic device; and forbidding displaying the message list on a main interface of the electronic device in response to that the current state is a screen unlocked state, the message list being configured to be displayed in response to that the electronic device is in a screen locked state.

With the non-transitory computer readable storage medium in the embodiment, the message of the application notification bar is obtained in response to that the application notification bar is triggered by the operating system of the electronic device, the message list is updated based on the message, in response to that the electronic device is in the screen unlocked state, it is forbidden to display the message list on the main interface of the electronic device, the message list is configured to be displayed in response to that the electronic device is in the screen locked state, such that the message list and the screen locked interface can be unbound, the maintenance independence of the lifecycle of the message list can be guaranteed, and the integrity and instantaneity of the message display can be improved.

In order to achieve the above embodiments, the present disclosure further provides a computer program product. When the instructions in the storage medium are executed by a processor, causes the method for processing a message on a screen locked interface to be performed. The method includes: obtaining a message of an application notification bar in response to that the application notification bar is triggered by an operating system of an electronic device; updating a message list based on the message; detecting a current state of the electronic device; and forbidding displaying the message list on a main interface of the electronic device in response to that the current state is a screen unlocked state, the message list being configured to be displayed in response to that the electronic device is in a screen locked state.

With the computer program product in the embodiment, the message of the application notification bar is obtained in response to that the application notification bar is triggered by the operating system of the electronic device, the message list is updated based on the message, in response to that the electronic device is in the screen unlocked state, it is forbidden to display the message list on the main interface of the electronic device, the message list is configured to be displayed in response to that the electronic device is in the screen locked state, such that the message list and the screen locked interface can be unbound, the maintenance independence of the lifecycle of the message list can be guaranteed, and the integrity and instantaneity of the message display can be improved.

It should be noted that, in description of the present disclosure, terms such as “first” and “second” are used herein for purposes of description and are not intended to indicate or imply relative importance or significance. In addition, in the description of the present disclosure, “a plurality of” means two or more than two, unless specified otherwise.

Any process or method described in a flow chart or described herein in other ways may be understood to include one or more modules, segments or portions of codes of executable instructions for achieving specific logical functions or steps in the process, and the scope of a preferred embodiment of the present disclosure includes other implementations, which should be understood by those skilled in the art.

It should be noted that, the various parts of the present disclosure may be realized by hardware, software, firmware or combinations thereof. In the above embodiments, a plurality of steps or methods may be stored in a memory and achieved by software or firmware executed by a suitable instruction executing system. For example, if it is realized by the hardware, likewise in another embodiment, the steps or methods may be realized by one or a combination of the following techniques known in the art: a discrete logic circuit having a logic gate circuit for realizing a logic function of a data signal, an application-specific integrated circuit having an appropriate combination logic gate circuit, a programmable gate array (PGA), a field programmable gate array (FPGA), etc.

It would be understood by those skilled in the art that all or a part of the steps carried by the method in the above-described embodiments may be completed by relevant hardware instructed by a program. The program may be stored in a computer readable storage medium. When the program is executed, one or a combination of the steps of the method in the above-described embodiments may be completed.

In addition, individual functional units in the embodiments of the present disclosure may be integrated in one processing module or may be separately physically present, or two or more units may be integrated in one module. The integrated module as described above may be achieved in the form of hardware, or may be achieved in the form of a software functional module. If the integrated module is achieved in the form of a software functional module and sold or used as a separate product, the integrated module may also be stored in a computer readable storage medium.

The above-mentioned storage medium may be a read-only memory, a magnetic disc, an optical disc, etc.

Reference throughout this specification to “an embodiment,” “some embodiments,” “an example,” “a specific example,” or “some examples,” means that a particular feature, structure, material, or characteristic described in connection with the embodiment or example is included in at least one embodiment or example of the present disclosure. The appearances of the above phrases in various places throughout this specification are not necessarily referring to the same embodiment or example of the present disclosure. Furthermore, the particular features, structures, materials, or characteristics may be combined in any suitable manner in one or more embodiments or examples. In addition, different embodiments or examples and features of different embodiments or examples described in the specification may be combined by those skilled in the art without mutual contradiction.

Although embodiments of the present disclosure have been illustrated and described, it would be appreciated that, the above-described embodiments are illustrative, and are not constructed as limiting the present disclosure, changes, modifications, alternatives and variations can be made by those skilled in the art in the scope of the present disclosure.

1. A method for processing a message on a screen locked interlace, comprising:
obtaining a message of an application notification bar in response to that the application notification bar is triggered by an operating system of an electronic device;
updating a message list based on the message;
detecting a current state of the electronic device; and
forbidding displaying the message list on a main interface of the electronic device in response to that the current state is a screen unlocked state, the message list being configured to be displayed in response to that the electronic device is in a screen locked state.

2. The method of claim 1, wherein after detecting the current state of the electronic device, the method further comprises:
displaying the message list on the screen locked interface of the electronic device in response to that the current state is the screen locked state.

3. The method of claim 1, wherein after forbidding displaying the message list on the main interface of the electronic device, the method further comprises:
storing the message list into a local cache.

4. The method of claim 3, wherein after forbidding displaying the message list on the main interface of the electronic device, the method further comprises:
detecting whether the electronic device enters into the screen locked state; and
displaying the message list on the screen locked interface of the electronic device in response to that the electronic device re-enters into the screen locked state.

5. The method of claim 3, wherein updating the message list based on the message comprises:
querying whether the message list is stored in the local cache;
updating the message list directly based on the message in response to that there is the message list stored in the local cache; and
establishing a message list, and taking the established message list as the message list in response to that there is no message list stored in the local cache.

6. The method of claim 1, wherein before obtaining the message of the application notification bar, the method further comprises:
obtaining an access authority to the application notification bar.

7. The method of claim 1, herein the message is generated by an instant messaging application.

8. The method of claim 1, wherein the message comprises an icon of an application from which the message comes, the number of messages in a notification bar, a prompt mode of a notification bar, and a behavior mode after clicking a notification bar.

9. An electronic device, comprising:
a processor; and
a memory, configured to store executable program codes;
wherein the processor is configured to run a program corresponding to the executable program codes by reading the executable program codes stored in the memory, to:
obtain a message of an application notification bar in response to that the application notification bar is triggered by an operating system of an electronic device;
update a message list based on the message;
detect a current state of the electronic, device; and
forbid displaying the message list on a main interface of the electronic device in response to that the current state is a screen unlocked state, the message list being configured to be displayed in response to that the electronic device is in a screen locked state.

10. The electronic device of claim 9, wherein the processor is further configured to:
display the message list on the screen locked interface of the electronic device in response to that the current state is the screen locked state.

11. The electronic device of claim 9, wherein the processor is further configured to:
store the message list into a local cache.

12. The electronic device of claim 11, wherein the processor is further configured to:
detect whether the electronic device enters into the screen locked state; and
display the message list on the screen locked interface of the electronic device in response to that the electronic device re-enters into the screen locked state.

13. The electronic device of claim 11, wherein the processor is further configured to:
query whether the message list is stored in the local cache;
update the message list directly based on the message in response to that there is the message list stored in the local cache; and
establish a message list, and take the established message list as the message list in response to that there is no message list stored in the local cache.

14. The electronic device of claim 9, wherein the processor is further configured to:
obtain an access authority to the application notification bar.

15. The electronic device of claim 9, wherein the message is generated by an instant messaging application.

16. The electronic device of claim 9, wherein the message comprises an icon of an application from which the message comes, the number of messages in a notification bar, a prompt mode of a notification bar, and a behavior mode after clicking a notification bar.

17. A non-transitory computer readable storage medium having stored thereon computer programs that, when executed by a processor, causes a method for processing a message on a screen locked interface to be implemented, the method comprising:
obtaining a message of an application notification bar in response to that the application notification bar is triggered by an operating system of an electronic device;
updating a message list based on the message;
detecting a current state of the electronic device; and
forbidding displaying the message list on a main interface of the electronic device in response to that the current state is a screen unlocked state, the message list being configured to be displayed in response to that the electronic device is in a screen locked state.

18. (canceled)
